(19) United States
(12) Patent Application Publication
(10) Pub. No.: US 2013/0279162 A1
(43) Pub. Date: Oct. 24, 2013

(54) Beacon, Especially for a Wind Turbine

(71) Applicants: Lars Hohaus, Visnenburg (DE); Vincent Kessler, Hannover (DE)

(72) Inventors: Lars Hohaus, Visnenburg (DE); Vincent Kessler, Hannover (DE)

(73) Assignee: Quantec Networks GmbH, Hannover (DE)

(21) Appl. No.: 13/810,664

(22) PCT Filed: Jul. 6, 2011
(86) PCT No.: PCT/DE11/01429

§ 371 Date: Jul. 11, 2013

(30) Foreign Application Priority Data
Jul. 16, 2010 (DE) 10 2010 027 529.8

(51) Int. Cl. F21K 99/00

(52) U.S. Cl. CPC F21K 9/00
USPC 362/231

(57) ABSTRACT

A beacon, especially for a wind turbine, comprising a support structure; at least two different LED units circumferentially mounted thereon and directed outwardly and alternating in a circumferential direction, with emitted light of first and second ones of the LED units differing with respect to their spectral compositions and being activatable separately from one another; and a linear lens disposed outwardly of the LED units, extending the circumferential direction, and serving to bundle light emitted from the LED units, with the linear lens being shared by all of the LED units.

The present invention relates to a beacon or navigational light, which can be mounted as an obstacle lighting or illumination, especially on a wind wheel or wind turbine, or for example on a high support structure or high building. Such a beacon can thus emit light as a warning to flying objects.

The types of light emitted by beacons are defined by various national or international standards, e.g. the ICAO Annex 14. In this connection, lights having different color values, for example white or red, various flashing frequencies, and intensity distributions are defined. The intensity distributions can furthermore be defined by lower and upper thresholds in the horizontal plane and for various vertical deviation angles relative to the horizontal plane, in order on the one hand to ensure adequate intensities for the recognition of obstacles, and on the other hand to avoid an excessive glare and blinding of, for example, surrounding buildings or people in the vicinity.

DE 10 2007 009 896 B4 describes a beacon having a plurality of light-emitting diodes (LEDs) that are disposed on a circle and are directed radially outwardly. Associated with most of the LEDs is a common fresnell lens that extends around in the circumferential direction and is provided concentrically relative to the LED arrangement. Disposed in front of the individual LEDs are respective ancillary lenses in order to direct the light of the LEDs to the fresnell lens, so that relative to the fresnell lens the LEDs assume a radially inwardly offset virtual projection that is also offset relative to the focus of the fresnell lens. DE 20219037 U1 also describes a beacon having a plurality of LEDs.

By using LEDs, it is possible to save a considerable amount of power in contrast to earlier lighting means, e.g. halogen lights. By using the ancillary lenses of DE 10 2007 009 896 B4, the optical characteristics of the LEDs can be appropriately altered.

However, with this approach it is in part problematic to achieve the various required radiation characteristics. Thus, such beacons are generally suitable only for specific types of lights.

DE 20 2007 005 003 U1 describes a beacon where a plurality of lighting means are disposed in different light-emitting planes, whereby the various planes are formed by LEDs of different colors. Individual lens elements are associated with each of the plurality of light-emitting planes, with the transitions of the lens elements being separated from one another by shielding rings.

Such beacons are in general customary for forming the various types of lights. Depending upon the required beacon, e.g. depending upon the time of day, the different light radiation planes are turned on, and the respectively non-light radiating planes are turned off. The light radiation planes extend parallel to one another and are disposed one above the other. In this connection, for example a plurality of light radiating planes for white LEDs and one light radiating plane for red LEDs can be provided.

Such a type of construction results in a correspondingly greater vertical extension. The complex wiring is generally effected by means of additional switching boxes, which are mounted externally of the light arrangement.

In other technical fields besides beacons, for example with portable lamps, such as in DE 100 59 844 A1, multi-colored light circuits having different colored LEDs are known in order to emit different colors without a further optical orientation of the light radiation by optical means, etc.

It is an object of the present invention to provide a beacon that can be constructed with little expense, and can be used for various types of lights.

This object is realized by a beacon according to claim 1. The dependent claims describe preferred further developments.

Thus, different LED units are alternately disposed in the circumferential direction, preferably in a common horizontal plane. The different LED units differ from one another at least with respect to their spectral composition, whereby they can in particular be white and red

LED units, or can alternatingly emit white and red light. The different LED units can be separately activated; in particular, the first LED units can be activated together, and correspondingly the second LED units can be activated together.

In principle, more than two different LED units can also be alternatingly disposed in the circumferential direction. However, it is recognized that in principle the provision of two different LED units, e.g. an LED unit for white light and a further LED unit for red light, is sufficient, since the LED units for different types of light can also be variously activated.

The alternating arrangement can be rigorously alternating, i.e. in the sequence
first LED unit—second LED unit—first LED unit—etc.
   In principle, however, deviations from this rigid sequence can also be provided with different periodic arrangements; what is relevant is that in the various directions of the horizontal plane, an overlap of the light cone respectively of the first LED units and respectively of the second LED units occurs in such a way that the desired or required light intensities result.

The individual LED units can be respectively formed by a single LED, e.g. a white LED for white light. However, an LED unit can also have a plurality of individual LEDs that are disposed next to one another and also vertically one above the other. These LEDs of a common LED unit can, in particular, be disposed at the same radius or spacing relative to the common linear lens, and can thus be disposed next to one another in a compact structure. In contrast to the formation of a plurality of vertical LED rows, which respectively extend in a circumferential manner about the support structure, with the present invention the foregoing design results in a significantly more compact configuration.

In particular, however, by means of different LEDs of a common LED unit, i.e. with a common, circumferential linear lens that has only a single focal ring, it is possible by varying the activation control to achieve different illumination intensity distributions; thus, different types of light can be formed. These differences can be in the form of the light intensities in the horizontal direction, and furthermore also in the vertical light intensity distribution, in other words, in the light intensity distributions in vertical angles relative to the horizontal plane.

In this connection, it is recognized that the in part very strict limits pursuant to various national and international standards for the radiation characteristics can be implemented very well by the plurality of LEDs per LED unit. Thus, for example, one or two LEDs can be disposed in the horizontal plane, and further LEDs can be somewhat vertically offset relative thereto. The vertically offset LEDs thus contribute more greatly to light intensity distributions at an angle relative to the horizontal plane.

A desired light intensity distribution in the vertical direction can thus be provided by overlapping LEDs at various spacings relative to the horizontal plane. By means of the ability to separately activate, and by the different supplies of power to the individual LEDs of an LED unit, it is thus possible with a great variability and a high precision to achieve different radiation characteristics.

The linear lens is preferably a linear Fresnell lens. Its focal ring is concentric to the axis of symmetry.

Pursuant to a particularly advantageous embodiment, the various LED units can differ not only with respect to their spectral composition, but also in a further parameter. This parameter can, in particular, be a different defocusing that can in particular be formed by a different spacing relative to the common lens. It is recognized that by means of the different defocusing a common circumferential lens can be used for different vertical light intensity distributions, and thus different types of light.

The varying radial distances can, for example, be formed by providing vertical ribs, in other words raised portions and recessed portions, that extend alternatingly in the circumferential direction of the support structure. Alternatively, it would in principle also be possible to provide carrier elements of the individual LEDs that differ in thickness, or are stacked, on a cylindrical surface, so that the support structure is multi-sectional, with the cylindrical body and the carrier elements, for example circuit carriers, placed thereon which form the raised portions or ribs. However, the formation of radial recessed portions and raised portions in a one-piece support structure results in a greater fabrication precision and the possibility that these elements respectively have a planar surface and thus the printed circuit boards or carrier elements of the LED units as planar elements can be mounted laminarly and can thus be unequivocally positioned. For this purpose, for example a metal cylinder can be suitably milled. In principle, however, it would also be possible to use a multi-part support structure.

A varying defocusing can also be achieved by means of ancillary optics disposed in front of the individual LED units, for example only in front of the first or second LED units. Thus, the radial offset, or the varying radial spacings, can be eliminated.

Further parameters that contribute to the varying activation can include varying flashing frequencies or current intensities.

It will be understood that the configuration that alternates in a circumferential manner, in particular alternating with respect not only to the spectral composition but also with respect to a different defocusing, in a particular manner is synergistically supplied by providing one of the two LED units with a plurality of vertically offset individual LEDs. This combination takes into account in a special manner that the different types of lights also require different vertical light intensity distributions, in part with upper and lower thresholds. These special requirements can be achieved with a single linear lens, i.e. with a single focal ring, in a particularly advantageous manner by combining the different defocusing with the vertical offset.

The support structure can, in particular, be a support tube, in other words a cylindrical inner housing. In this connection, this support tube can also serve for the connection of the cover and base between which the Fresnell lens is accommodated. A transparent tube of, for example, polymeric material or also glass can be provided for sealing purposes relative to the exterior space, whereby the transparent tube can be provided outwardly of the Fresnell lens and the metal cylinder, in particular directly externally of the Fresnell lens. Thereby results a compact, narrowly constructed, preferably cylindrical block.

The electronic control device or control components can be provided, for example, on the cover or base on a printed circuit board or some other circuit carrier, so that this compact unit can be connected directly to a power supply. The circuit carrier can extend, for example, over the entire cross-sectional area of the base or cover, thus making possible short wiring paths to the LED units. In principle, the control device can also be formed by a plurality of components or individual, cooperating control devices, e.g. two control devices for the different-colored LEDs.

The different LED units, and in particular also individual LEDs within the LED units, can advantageously be activated through separate channels. The activation can in particular be effected via PWM (Pulse Width Modulation) since in so doing different light intensities without change in polarity can be formed. The pulse frequency of the PWM is in this connection not significant for a beacon. In particular, the typical cycle rates of PWM are significantly higher, or of high frequency, than are the flashing frequencies, which for example lie in the hertz range.

It is furthermore recognized that a coating of the surfaces that are disposed in the radiation region of the LEDs with a light-absorbing material is helpful to maintain the radiation characteristics. For example, pertinent surfaces on the cover and on the base that are disposed in the radiation region of the LEDs can be appropriately coated.

The linear lens preferably has a single focal ring, or an annular focus that extends concentrically relative to the axis of symmetry of the beacon.

The linear lens extends in a ring-shaped manner, extending entirely around in the circumferential direction about the support structure, and the beacon preferably emits in 360° of the horizontal plane; if necessary, a portion of the LEDs can be switched off, for example at corner regions of a wind field or on buildings.

The invention will be explained in the following with the aid of the accompanying drawings of one exemplary embodiment. Shown are:

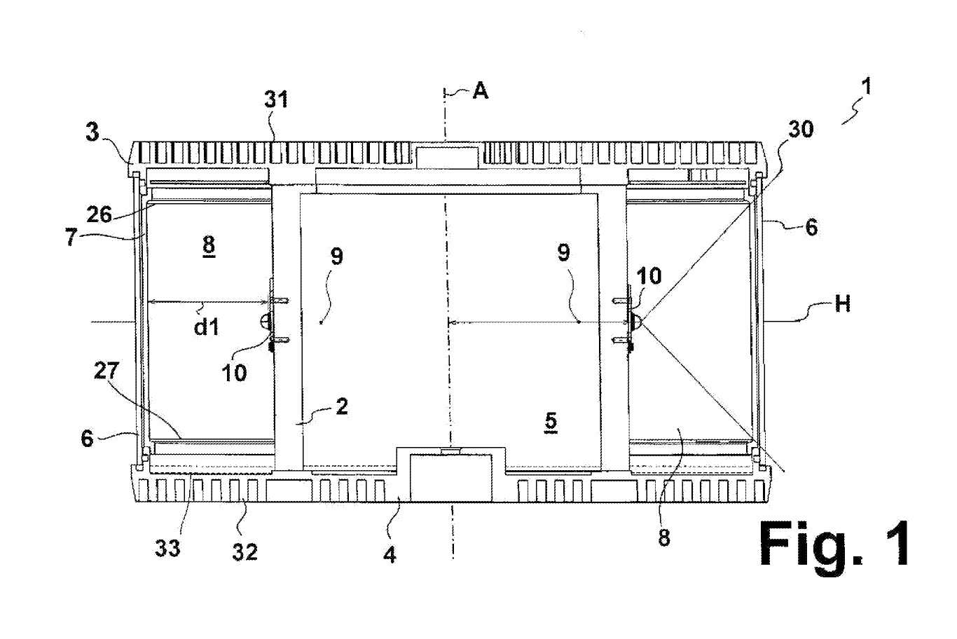

FIG. 1 a cross-sectional, i.e. axial section of a beacon pursuant to an exemplary embodiment of the invention,

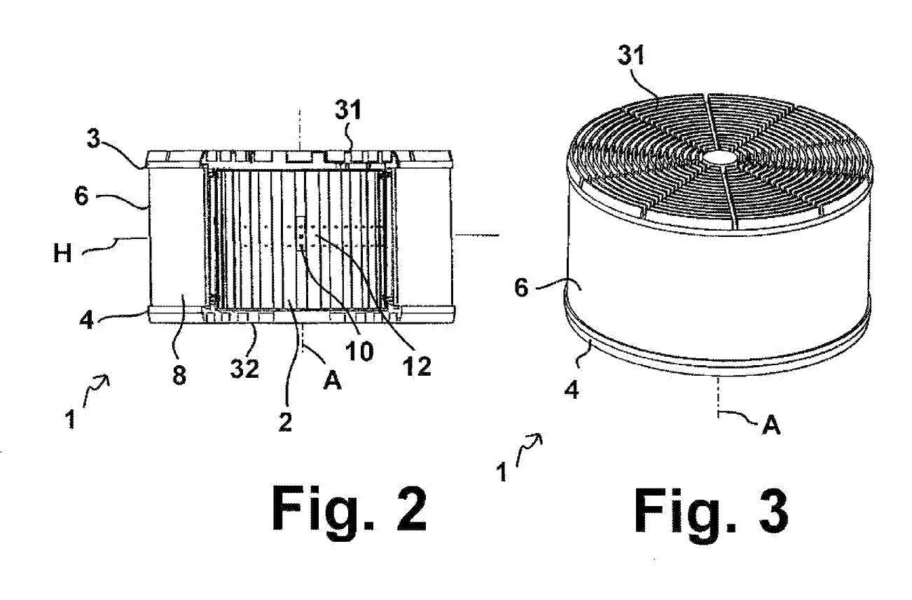

FIG. 2 a side view of the beacon;

FIG. 3 a perspective view of the beacon;

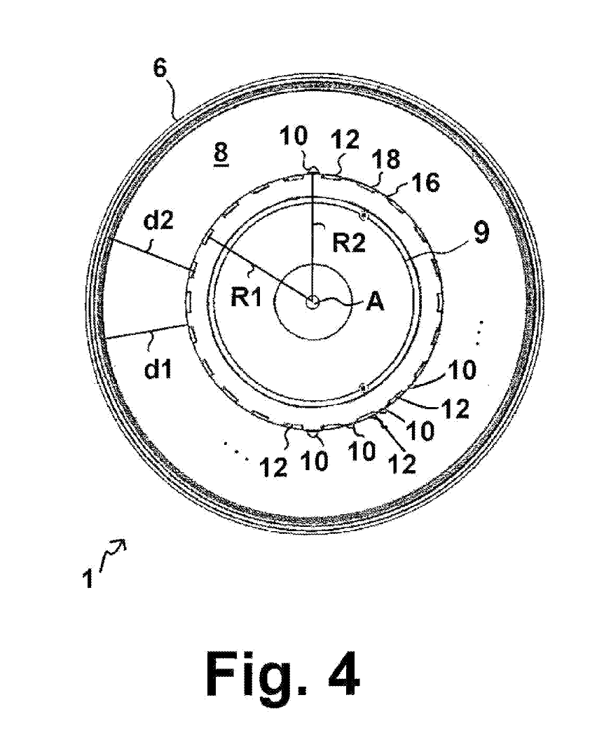

FIG. 4 a radial section through the beacon;

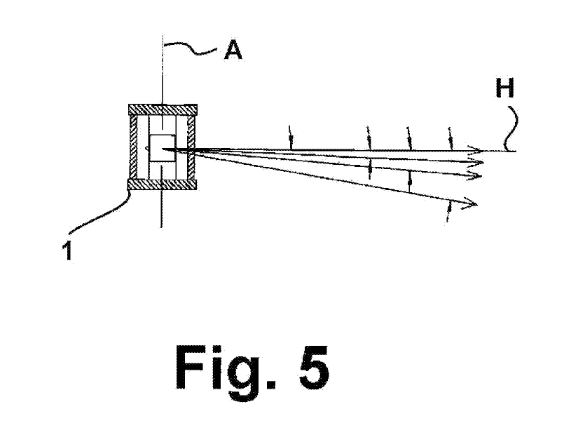

FIG. 5 a very schematic illustration of the vertical radiation angle of the beacon;

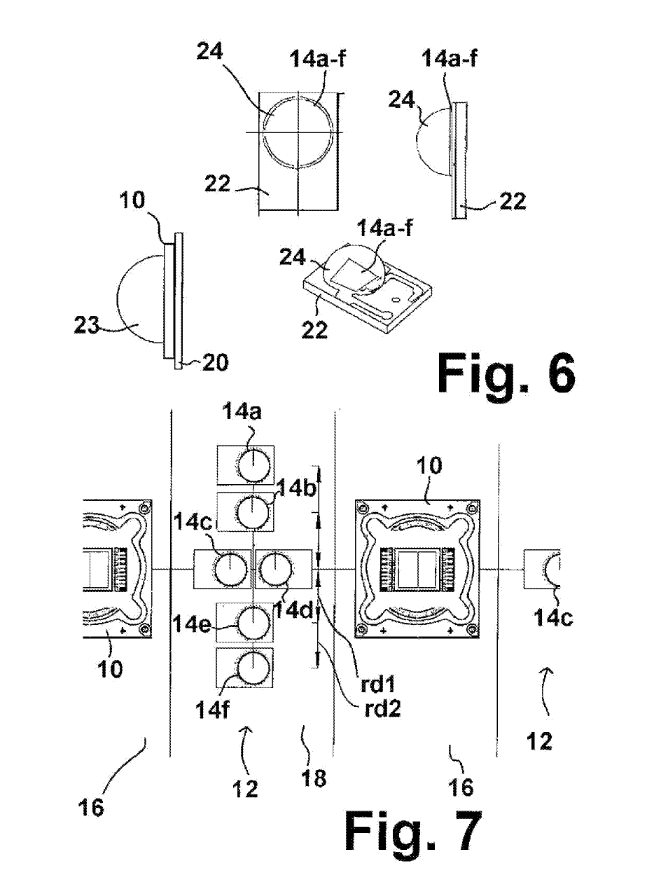

FIG. 6 front, side and perspective views of the LED unit;

FIG. 7 a side view onto the inner cylinder with adjacent LED units;

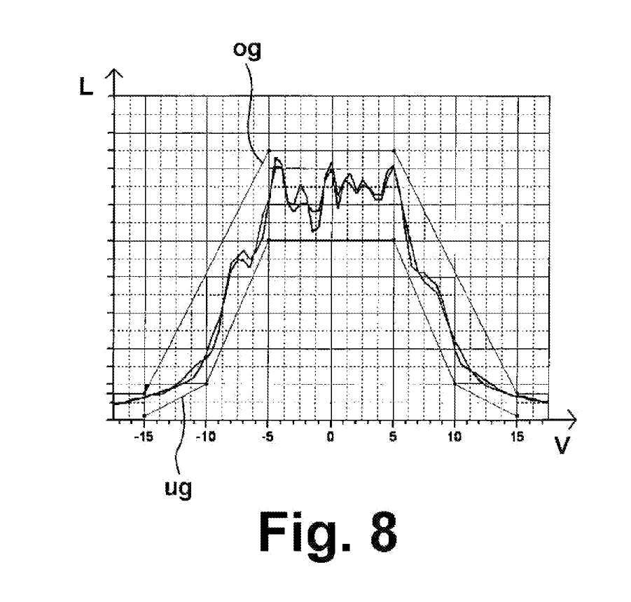

FIG. 8 a graph of the light intensity distribution versus the vertical angle for one example of a light (Light W Red-ES);

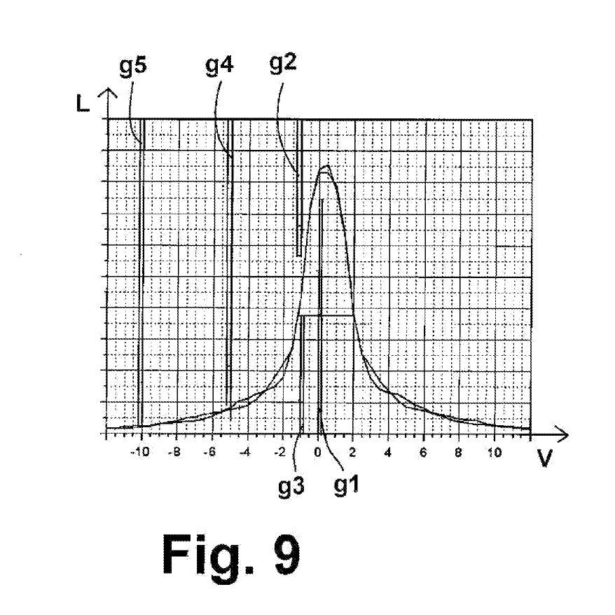

FIG. 9 the vertical light distribution for a white light pursuant to ICAO Annex 14, average intensity Type A;

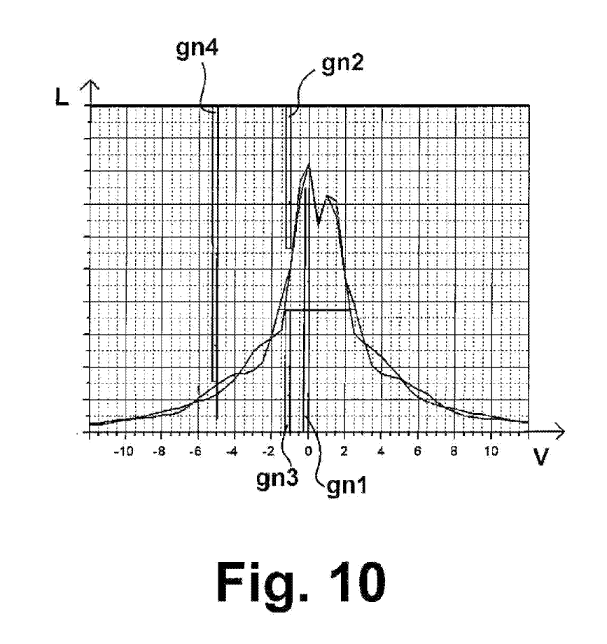

FIG. 10 the vertical light distribution for a red light pursuant to ICAO Annex 14, average intensity Type B or Type C.

A beacon or navigation light 1 serves as an obstruction or obstacle illumination or lighting, and can, for example, be mounted on a wind wheel or turbine. The beacon 1 has an essentially cylindrical inner housing 2, preferably made of metal, e.g. aluminum, a cover 3, for example of aluminum, fastened onto the inner housing 2, and a base 4, for example aluminum, fastened to the underside of the inner housing 2. The inner housing 2 has an axis of symmetry A, and surrounds an interior 5 of the housing. Radially outwardly of the inner housing 2, a linear Fresnell lens 7 is disposed in the circumferential direction and extending about the axis of symmetry A. The Fresnell lens 7 is thus disposed concentrically relative to the inner housing 2. The Fresnell lens 7 is advantageously mounted on the cover 3 and the base 4. An intermediate space 8 is formed between the inner housing 2 and the Fresnell lens 7, whereby the intermediate space 8 is connected with the housing interior 5, or can merge therewith, and thus a pressure equalization exists between the intermediate space and the housing interior. The intermediate space 8 is delimited toward the top and toward the bottom by the cover 3 and the base 4. A pressure equalization is advantageously made possible between the interior 5 and the exterior space that surrounds the beacon 1; this pressure equalization can be made possible, for example, via a membrane or diaphragm. A tube 6 of transparent polymeric material, e.g. acrylic glass, but also glass, can advantageously be disposed in a circumferential manner radially outwardly of the Fresnell lens 7 as a transparent cover and seal relative to the exterior space. The linear Fresnell lens 7 can be formed from an acrylic glass or transparent polymeric material, e.g. PMMA.

LED units 10, 12 are mounted on the outer periphery of the inner housing 2. The LED units 10, 12 are distributed in the circumferential direction and are spaced relative to one another in a regular manner. Pursuant to this embodiment, two different LED units, namely a white LED 10 as a first LED unit, and a red LED arrangement 12 as a second LED unit, are alternatingly disposed in the circumferential direction, and advantageously essentially on a common horizontal plane H through the axis A. In FIG. 1, by way of example two white LEDs 10 are illustrated, and in FIG. 4 by way of example a number of the white LEDs 10 and the LED arrangements 12. There results in the circumferential direction an alternating, regularly spaced arrangement. Thus, each white LED 10 and each red LED arrangement 12 can respectively be associated with one segment in the horizontal plane H. In reality, however, the LED units 10 and 12 emit over a larger angular range in the horizontal direction, so that toward the outside, an overlap of the respectively illuminating LED units 10 or 12 results.

The LED units 10 and 12 can differ in various parameters or also a combination of various parameters. First of all, the frequency spectrum can vary: the white LEDs 10 emit white or high-frequency light over a greater wavelength range. The red LED arrangements 12 have, pursuant for example to FIG. 7, a plurality of individual red LEDs, and pursuant to the illustrated embodiment six LEDs 14a, 14b, 14c, 14d, 14e, 14f. In this connection, the red LEDs 14c and 14d are mounted in the middle, and thus essentially on the horizontal plane H with the white LEDs 10; the vertically adjacent red LEDs 14b, 14e as well as the outer LEDs 14a, 14f are offset correspondingly vertically or in the axial direction thereto with spacings rd1 and rd2 relative to the horizontal plane H. A single Fresnall lens 7 having a single focal ring 9 is provided for all red LEDs 14a to f. The position or radius of the focal ring 9 in FIGS. 1 and 4 is merely by way of example.

The outer surface of the inner housing 2 is provided with raised portions 16 and recessed portions 18 that extend in the axial direction. The raised portions 16 and the recessed portions 18 thus extend parallel and in the axial direction A. The white LEDs 10 are disposed on the raised portions 16, and the red LED arrangements are disposed on the recessed portions 18. Thus, the radial spacings R1 of the white LEDs 10 relative to the axis A are slightly greater than the radial spacings R2 of the red LED arrangements 12. Correspondingly, the distances D1 of the white LEDs 10 relative to the Fresnell lens 7 are slightly less than the distances D2 of the red LED arrangements 12. Thus, it is possible to achieve a diverse defocusing of the various LED units 10 and 12 in order to achieve desired optical characteristics, in particular to enable a desired vertical fanning out. In this connection, the recessed portions 18 and the raised portions 16 enable greater and more precise differences in the radii than do, for example, small bonded or adhesively mounted carrier plates.

The raised portions 16 and the recessed portions 18 can advantageously be provided with planar outer surfaces in order to be able to respectively accommodate the LED carriers 20 and 22 of the white LEDs 10 and the red LEDs 14a to 14f in a laminar manner. The LEDs can, in a manner known per se, be respectively embodied as a die or a semiconductor die having a spreader 23, 24 that influences the optics on the LED carriers 20 and 22 respectively, along with supplemental connection contacts and possibly also already a control circuit.

The white LEDs 10 can, for example, have illumination surfaces of 3×3 mm² with a height of 0.9 mm, for example at a dominant wave length of 550 nm. They can in principle also be embodied as pure surface emitters, whereby their spreaders 23 already define a certain amount of focusing, which can be further defined by the optical characteristics of the fresnal lens 7.

The red LEDs 14a to 14f can, for example, respectively have illumination surfaces of 1×1 mm² with a height of 0.6 mm, with their dominant wavelength being, for example, 617 nm.

The radius R2 of the red LEDs 14a to 14f can, for example, be R2=99.6 mm and the first radius R1 of the white LEDs 10 can, for example, be 102 mm, i.e. 2.4 mm greater than the red LEDs 14a to 14f.

The fresnell lens 7, which is in common for the LED units 10 and 12, is linear, in other words, in the axial direction A (vertical direction) in a known manner it has a plurality of lens sections having varying curvature, which thus optically simulate a larger lens, or a very convex lens, in particular a very convex flat lens. The single focal ring 9 of the Fresnell lens 7 extends coaxially relative to the axis of symmetry A, and is disposed in the horizontal plane H. The position of the Fresnell lens 7 is unambiguously determined in that it is fixed between the cover 3 and the base 4, for example by appropriate notches, grooves or recesses in the cover 3 and the base 4. The Fresnell lens 7 can, for example, have a radius of 166 mm. The plain side of the Fresnell lens 7 is disposed on the inside, and the structured side is disposed on the outside. The overall height and thus aperture of the Fresnell lens 7, is, for example, 110 mm. The transparent tube 6 can, for example, have an outer radius of 170 mm with a thickness of, for example, 5.

By way of example, forty-eight LED units 10, 12 can be provided, in other words, twenty-four LEDs 10, as well as twenty-four LED arrangements 12, so that each LED unit 10 or 12 corresponds to a segment of 7.5°.

The white LEDs 10 and the red LED arrangements 12 can be supplied with power independently of one another, and with different patterns, with three types of beacons being shown in FIG. 8 to FIG. 10. In each case, the light intensity L, unit candela cd is plotted as a function of the vertical radiation angle V (in degrees or °), i.e. pursuant to FIG. 5 the angle versus H.

FIG. 9 shows a white blinking or strobe light, including the threshold values of the light distribution, indicated by the bars g1, g2, g3, g4, pursuant to the statutory standard relative for this, namely ICAO, Annex 14, Type A average intensity, color white, flashing light with 20 to 60 flashes per minute, 20,000 cd/in² or 2,000 cd/m. These lights can thus be obtained exclusively with the white LEDs 10, and in particular for 20,000 cd/in² or 2,000 cd/m with varying current intensity.

FIG. 8 shows the light intensity distribution Light-W-Red-ES (LWR-ES) for a red flashing light, which illustrates red flashing light at an intensity of 150 cd in the horizontal H. This light intensity distribution is also strictly regulated. For the specification LWR-ES where ES stands for Expanded Specification, there results a narrow band that is defined by the upper limit og, which in the graph is essentially trapezoidal shaped, and the lower limit ug, and for each vertical angle value permits only a relatively narrow band of, for example, approximately 85 cd, and at greater angles above 10° or below −10° even smaller. These strict standards are also achieved. In FIG. 8, for this purpose a total of six LEDs 14a to 14f of the red LED arrangement 12 are activated, without activating the white LEDs 10, for example in the following selection:
14a, with 6.1 lm (lumen), 14b, with 7.8 lm, 14c, 14d, each with 3.3 lm, 14e with 7.1 lm, 14f with 6.5 lm, thus together a total light flux of 34 lm.
   In FIG. 8, the efficiency is, for example, 57%, and hence corresponds to the value for RbT of FIG. 10.

For the red beacon of FIG. 10 pursuant to ICAO, Annex 14, average intensity Type B (flashing) flashing light 20 to 60 flashes per minute, peak intensity 2,000 cd/m, with the red LED arrangement 12 only the central four LEDs 14b, 14c, 14d, 14e, but not the outer red LEDs 14a, 14f are activated. In this connection, for example the central LEDs 14c, 14d, with an appropriate activation, contribute 38 lm, and the adjacent red LEDs 14b, 14e each contribute 4.5 lm, so that the four LEDs 14b to 14d together yield 85 lm. The bars gn1 to gn4 indicate the threshold values. Furthermore, it is hereby possible to also fulfill ICAO Annex 14, average intensity type C (steady light).

In the measurement curves of FIG. 8 and FIG. 10, in particular in the middle portion a plurality of peaks can be recognized, which originate from the individual red LEDs. The overall curve yields an overlap of the intensity distributions of all of the LEDs, i.e. in FIG. 10 the LEDs 14b, 14c, 14d, 14e and in FIG. 8 all of the LEDs 14a to 14f.

The vertical light intensity distribution according to FIG. 8 and FIG. 10 is thus determined by first of all the vertical arrangement of the individual red LEDs 14a to 14f, i.e. in particular also the vertical spacings rd1 of the red LEDs 14b, 14e as well as the vertical spacings rd2 of the red LEDs 14a, 14f, furthermore by the spreader 24 of the red LEDs 14a to 14f, the radial distance d2 of the entire red LED arrangement 12 from the Fresnell lens 7, as well as the optical characteristics of the Fresnell lens 7.

Thus, the following parameters can be varied: Number of LEDs per LED arrangement 12, power supply or light intensity of the individual LEDs 14a to 14f as well as 10, whereby in particular different LEDs 14a to 14f of an LED arrangement 12 can have different power supplied to them, furthermore the radii R1, R2 or distances d1, d2 to the common Fresnell lens 7, as well as the spectral distribution or wavelengths.

As further parameters, instead of, or in addition to, the raised portions 16 and the recessed portions 18, ancillary optics can be placed upon the LEDs 10 and/or 14a to 14f, as a result of which the varying defocusing can be achieved.

Cooling ribs 31, 32 are advantageously formed on the cover 3 and on the base 4, and in the illustrated embodiment, however, have no support functions.

The light 30 emitted from the white LED 10 is indicated in FIG. 1. The Fresnell lens 7 acts as an aperture. The inner surfaces 26, 27 on the underside of the cover 3 and the upper side of the base 4 are advantageously coated with a light-absorbing material so as to not influence the radiation characteristic.

A control device 33 is formed, for example, by a circuitry carrier, in particular a printed circuit board that accommodates components, and serves for the activation of the LED units 10 and 12. The control device 33 can in particular be secured to the base 4 or also to the cover 3. The control device 33 preferably extends over substantially the entire cross-sectional area, i.e. over the interior 5 of the housing and the intermediate space 8, so that the leads or wiring for contacting the LED units 10, 12 are short. Among other things, the energization means for the various types of lights is stored in the control device 33.

It is also possible for the control device 33 to not activate all of the white or red LED units 10 and 12 over the entire circumference, but rather only within an angle of less than 360° in the horizontal plane H, for example for corner positions in a wind turbine field.

### REFERENCE NUMERAL LIST

1 Beacon or navigation light
2 Cylindrical inner housing
3 Cover
4 Base
5 Interior of housing
6 Transparent tube
7 Linear fresnel lens
8 Intermediate space
9 Focal ring
10 White LED as first LED unit
12 Red LED arrangement
14a, 14b, 14c, 14d, 14e, 14f Red LEDs
16 Raised portions
18 Recessed portions
20, 22 LED carriers
23, 24 Spreader
26, 27 Inner surfaces of the intermediate space 8
30 Light
31, 32 Cooling ribs
33 Control Device
A Axis of symmetry
d1 Distances of the white LEDs 10 relative in the fresnell lens 7
d2 Distance of the red LED arrangements 12
g1, g2, g3, g4 threshold values of the light distribution
gn1 to gn4 threshold values as bars
H horizontal plane
og upper limit
ug lower limit
rd1 and rd2 spacings relative to the horizontal plane H
R1 radial spacings of the white LEDs
R2 radial spacings of the red LED arrangements 12
V Vertical radiation angle

1-15. (canceled)

16. A beacon, comprising:
a support structure (2); at least two different LED units (10, 12) circumferentially mounted on said support structure (2) and directed outwardly, wherein said at least two different LED units (10, 12) alternate in a circumferential direction, further wherein emitted light of first ones (10) of said LED units and of second ones (12) of said LED units differ with respect to their spectral compositions, and wherein said first and second ones (10, 12) of said LED units are configured to be activated separately from one another; and
a linear lens (7) disposed radially outwardly of said LED units (10, 12), and extending in a circumferential direction, wherein said linear lens (7) serves for bundling of light (30) emitted from said LED units (10, 12) and wherein said linear lens (7) is shared by all of said LED units.

17. A beacon according to claim 16, wherein said ones (10) of said LED units give off white light, and wherein said second ones (12) of said LED units give off red light.

18. A beacon according to claim 17, wherein said first and second ones (10, 12) of said LED units furthermore differ in at least one of the following parameters:
number of LEDs (10, 14a, 14b, 14d, 14e, 14f) per LED unit (10, 12); light intensity.

19. A beacon according to claim 17, wherein said first and second ones (10, 12) of said LED units furthermore differ in at least one of the following parameters:
radial spacing (R1, R2) relative to an axis of symmetry (A) of said beacon (1) and radial distance (d1, d2) relative to said shared linear lens (7).

20. A beacon according to claim 19, wherein said support structure (2) is alternatingly provided with alternating radial recessed portions (18) and radial raised portions (16) to form said different radial spacings (R1, R2) of said first and second ones (10, 12) of said LED units relative to said axis of symmetry (A) and/or to form said different distances (d1, d2) of said first and second ones (10, 12) of said LED units relative to said shared linear lens (7).

21. A beacon according to claim 20, wherein said radial recessed portions (18) are vertical grooves.

22. A beacon according to claim 20, wherein said white LED units (10) are disposed on said raised portions (16), and wherein said red LED units (12) are disposed on said recessed portions (18).

23. A beacon according to claim 17, which further includes a base (4) and a cover (3), wherein said support structure (2) is configured as a cylindrical inner housing, further wherein said base (4) and said cover (3) are mounted on end faces of said inner housing (2), and wherein said linear lens (7) is accommodated between said base (4) and said cover (3).

24. A beacon according to claim 23, wherein inner surfaces (26, 27) of said cover (3) and said base (4) provided in an intermediate space (8) between said support structure (2) and said linear lens (7) are provided with a light-absorbing coating.

25. A beacon according to claim 17, wherein at least one of said first and second ones (10, 12) of said LED units is provided with a plurality of individual LEDs (14a, 14b, 14c, 14d, 14e, 14f), and wherein at least some of said individual LEDs are configured to be activated separately from one another.

26. A beacon according to claim 25, wherein at least some of said plurality of individual LEDs (14a, 14b, 14c, 14d, 14e, 14f) of said second ones (12) of said LED units are disposed one above one another, and wherein a vertical light intensity distribution of said second ones (12) of said LED units that is provided with said plurality of individual LEDs is a function of:
vertical distances between said individual LEDs (14a, 14b, 14c, 14d, 14e, 14f) and energization of said individual LEDs (14a, 14b, 14c, 14d, 14e, 14f), and individual vertical light intensity distributions of said individual LEDs (14a, 14b, 14c, 14d, 14e, 14f).

27. A beacon according to claim 26, wherein said vertically spaced-apart individual LEDs (14a, 14b, 14c, 14d, 14e, 14f) of said second ones (12) of said LED units, where at least two different types of light are provided, are energized with different current distributions.

28. A beacon according to claim 27, wherein in one of said two types of lights, a portion of said individual LEDs (14b, 14c, 14d, 14e) of said LED unit (12) is energized, and wherein the remaining LEDs (14a, 14f) are not energized.

29. A beacon according to claim 28, wherein said non-energized LEDs are part of a red flashing light.

30. A beacon according to claim 17, which further comprises a central control device (33) for activation of said first and second ones (10, 12) of said LED units, whereby activation patterns for at least two different types of lights are stored in said central control device (33), and wherein one type of light is provided for energization of said red LED units (12) and at least one type of light is provided for energization of said white LED units (10).

31. A beacon according to claim 30, wherein said central control device (33) is mounted on one of said support structure (2), a cover (3) and a base (4).

32. A beacon according to claim 30, wherein said at least two different types of lights differ in at least one of the following parameters:
flashing frequency, light intensity in a horizontal plane, spectral composition, and vertical light intensity distribution.

33. A beacon according to claim 16, wherein said at least two different LED units (10,12) are disposed in a common horizontal plane.
